(19) United States
(12) Patent Application Publication
(10) Pub. No.: US 2023/0108352 A1
(43) Pub. Date: Apr. 6, 2023

(54) METHOD OF MANUFACTURING CELL UNIT SUBSTRATE

(71) Applicant: JOONGWOO M-TECH CO., LTD., Ansan-si (KR)

(72) Inventors: Sung Soo PARK, Yongin-si (KR); Jeong Won OH, Incheon (KR)

(73) Assignee: JOONGWOO M-TECH CO., LTD., Ansan-si (KR)

(21) Appl. No.: 17/943,259

(22) Filed: Sep. 13, 2022

(30) Foreign Application Priority Data
Oct. 1, 2021 (KR) 10-2021-0131239

(51) Int. Cl. C03B 33/02; C03C 15/00; C03C 21/00

(52) U.S. Cl. CPC C03B 33/0222; C03C 15/00; C03C 21/002

(57) ABSTRACT

A method of manufacturing a cell unit substrate, includes: a modified zone-formation step in which modified zones are formed along a predetermined cutting line on the mother substrate to be spaced apart from each other by a first distance by irradiating the mother substrate with laser beams having an energy intensity within an ablation threshold of the mother substrate along the cutting line, a modified zone-etching step in which through-holes are formed along the cutting line on the mother substrate to be spaced apart from each other by the first distance by etching the modified zones, a surface strengthening step in which the mother substrate having the through-holes therein is subjected to surface strengthening, with the mother substrate dipped in a strengthening solution, and a substrate separation step in which the cell unit substrates are separated from the surface-strengthened mother substrate.

### FIELD

The present invention relates to a method of manufacturing a cell unit substrate. More particularly, the present invention relates to a method of manufacturing a cell unit substrate, in which a mother substrate is subjected to surface strengthening before the mother substrate is diced into cell unit substrates, thereby facilitating post-processing with respect to the cell unit substrates while achieving substantial improvement in productivity.

### BACKGROUND

A display panel including a cover glass and the like used in a display apparatus, such as a smartphone and the like, is manufactured using a glass substrate.

Mass production of such a glass substrate can be achieved by dividing a plurality of cell unit substrates on a single mother substrate, followed by dicing the mother substrate into the cell unit substrates and separating each of the cell unit substrates therefrom.

Thereafter, each of the cell unit substrates is subjected to surface strengthening, in which compressive stress is imparted to a surface of the cell unit substrate to increase strength of the cell unit substrate, followed by functionalization, such as printing, patterning, lamination, and the like, according to use purpose, thereby providing a final product.

Such a cell unit substrate manufacturing process has the following problems.

First, each of the cell unit substrates separated from the mother substrate has a very small size, causing much poorer productivity than the mother substrate.

That is, since the cell unit substrates separated from the mother substrate have a small size, surface strengthening and functionalization treatment individually performed on each of the cell unit substrates, thereby causing significant deterioration in productivity.

Specifically, upon surface strengthening on the cell unit substrates, surface strength of the glass substrate is increased by compressive stress generated to a thickness of several dozen micrometers on the surface of the glass substrate through ion exchange with a strengthening solution. Such surface strengthening must be performed over the entire surface of each cell unit substrate, that is, over the entire surface of the cell unit substrate in cross-sectional view.

In order to perform individual surface strengthening on the cell unit substrates, a complicated apparatus and process for handling the cell unit substrates in the strengthening solution are used, thereby causing increase in production costs and significant deterioration in productivity due to the complicated process.

In order to solve such problems, surface strengthening is previously performed on the mother substrate before the cell unit substrates are separated from the mother substrate. However, as shown in FIG. 7, when a cell unit substrate 25 is diced on the mother substrate subjected to surface strengthening, the surface of the cell unit substrate 25 subjected to surface strengthening can have improved strength and durability through a surface strengthening effect due to balance between compressive stress f1 and expansive stress f2 generated on the surface of the cell unit substrate 25 by surface strengthening, whereas a cut surface 21 of the cell unit substrate 25 does not have the surface strengthening effect due to loss of compressive strength f1 corresponding to expansive strength, causing complete loss of the surface strengthening effect through breakage of the overall stress balance on the cell unit substrate 25.

Therefore, there is a need for a novel method of manufacturing a cell unit substrate, which can improve productivity through minimization of post-processing with respect to the cell unit substrates while improving strength and durability of the cell unit substrates through surface strengthening.

### RELATED LITERATURE

### Patent Document

Korean Patent Laid-open Publication No. 2017-0115595 (Publication Date: Oct. 17, 2017)

### SUMMARY

Embodiments of the present invention are conceived to solve such problems in the art and it is an aspect of the present invention to provide a method of manufacturing a cell unit substrate, which can achieve substantial improvement in productivity through surface strengthening of a mother substrate before the mother substrate is diced into cell unit substrates.

In accordance with one aspect of the present invention, a method of manufacturing a plurality of cell unit substrates from a mother substrate includes: a modified zone-formation step in which modified zones are formed along a predetermined cutting line on the mother substrate to be spaced apart from each other by a first distance by irradiating the mother substrate with laser beams having an energy intensity within an ablation threshold of the mother substrate along the cutting line; a modified zone-etching step in which through-holes are formed along the cutting line on the mother substrate to be spaced apart from each other by the first distance by etching the modified zones using an etching solution to remove the modified zones from the mother substrate, with the mother substrate dipped in the etching solution; a surface strengthening step in which the mother substrate having the through-holes therein is subjected to surface strengthening, with the mother substrate dipped in a strengthening solution, to form a strengthened depth portion to a depth greater than half of the first distance on a surface of each of the through-holes; and a substrate separation step in which the cell unit substrates are separated from the surface-strengthened mother substrate.

In one embodiment, the method may further include a substrate treatment step in which the cell unit substrates are treated to provide a functional layer to each of the cell unit substrates on the mother substrate, after the surface strengthening step.

In one embodiment, in the modified zone-formation step, the modified zones may be formed to have a diameter less than the first distance.

In one embodiment, in the substrate separation step, the cell unit substrates may be separated from the mother substrate by physical pressure applied to the cell unit substrates.

In the method according to the present invention, since surface strengthening is performed with respect to the cell unit substrates including the modified zones on the mother substrate before the cell unit substrates are separated from the mother substrate, a strengthened depth portion H1 can be evenly formed on the entire surface of each of the cell unit substrates on the mother substrate, thereby achieving substantial improvement in strength and durability of the cell unit substrates while improving productivity of the substrate.

In the method according to the present invention, a functionalization process is simultaneously performed with respect to the cell unit substrates on the mother substrate, thereby achieving further improvement in productivity of the substrate.

In the method according to the present invention, surface strengthening can be performed with respect to the cell unit substrates including the modified zones on the mother substrate to have a uniform surface-strengthened depth on the entire surface of each of the cell unit substrates without separation of the cell unit substrates from the mother substrate, thereby enabling easy and accurate separation of the cell unit substrates from the mother substrate through application of separation pressure thereto.

### DRAWINGS

The above and other aspects, features, and advantages of the present invention will become apparent from the detailed description of the following embodiments in conjunction with the accompanying drawings:

FIG. 1 is a flowchart of a method of manufacturing a cell unit substrate according to one embodiment of the present invention;

FIG. 2 is a view illustrating a modified zone formation step of FIG. 1;

FIG. 3 is a view illustrating a modified zone-etching step of FIG. 1;

FIG. 4 is a view illustrating a surface strengthening step of FIG. 1;

FIG. 5 is a view illustrating a substrate treatment step of FIG. 1;

FIG. 6 is a view illustrating a substrate separation step of FIG. 1; and

FIG. 7 is a partial sectional view depicting compressive stress applied to the entire surface of a cell unit substrate separated from a surface-strengthened mother substrate.

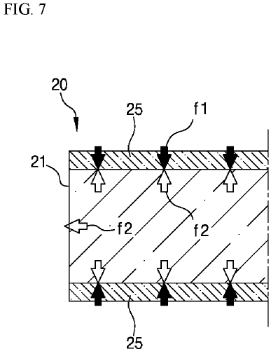

### DETAILED DESCRIPTION

Hereinafter, exemplary embodiments of the present invention will be described in detail with reference to the accompanying drawings. Like components will be denoted by like reference numerals throughout the specification.

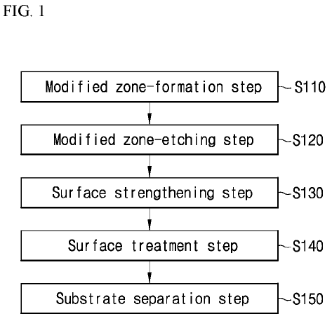

FIG. 1 is a flowchart of a method of manufacturing a cell unit substrate according to one embodiment of the present invention.

Referring to FIG. 1, the substrate manufacturing method according to one embodiment of the present invention is a method of manufacturing a plurality of cell unit substrates 200 from a mother substrate 100 and includes a modified zone-formation step S110, a modified zone-etching step S120, a surface strengthening step S130, and a substrate separation step S150.

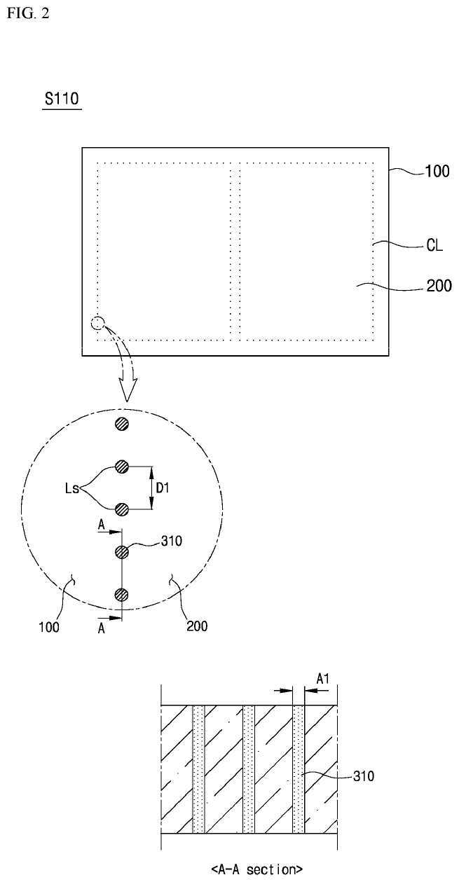

FIG. 2 is a view illustrating the modified zone formation step of FIG. 1.

Referring to FIG. 2, the modified zone-formation step S110 may be the step of forming modified zones 310 along a predetermined cutting line CL on a mother substrate 100 by irradiating the mother substrate 100 with laser beams along the cutting line.

In the modified zone-formation step S110, the laser beams may have an energy intensity within an ablation threshold of the mother substrate.

In addition, the laser beams may be very high frequency laser beams including picosecond pulse laser beams or femtosecond pulse laser beams. Upon irradiation of the mother substrate with such very high frequency laser beams, a melted layer may be formed in an irradiated region of the mother substrate without deformation of a material around the irradiated region. That is, upon irradiation with the picosecond pulse laser beams or the femtosecond pulse laser beams, thermal energy can be effectively applied only to the irradiated region, whereby the modified regions 310 formed along the cutting line CL can be clearly divided from each other.

In addition, the modified zones 310 irradiated with the pulsed laser beams may have a first diameter A1 and may be spaced apart from each other by a first distance D1 along the cutting line CL.

The first distance D1 may be greater than the first diameter A1. That is, among laser beam shots Ls delivered to the surface of the substrate, a distance (D1: first distance) between adjacent laser beam shots Ls is preferably greater than the size (A1: first diameter) of the laser beam shots Ls delivered to the surface of the substrate.

If the first distance D1 is less than the first diameter A1, the modified zones can overlap each other on the surface of the mother substrate, thereby causing disturbance of the laser beams due to a difference in index of refraction between the modified zones overlapping each other and the modified zones not overlapping each other.

Accordingly, since the first distance D1 is set to be greater than the first diameter A1, the modified zones 310 can be prevented from overlapping each other, thereby reducing a difference in the index of refraction without disturbance of the laser beams upon irradiation with the laser beams.

In addition, upon irradiation with the laser beams along the cutting line CL, the modified zones 310 may be formed inside the mother substrate 100 to be placed at a location spaced apart from the surface of the mother substrate 100 by a certain distance. Specifically, the modified zones 310 may be formed inside the mother substrate 100 to be spaced apart from an upper surface of the mother substrate 100 by a predetermined distance and from a lower surface of the mother substrate 100 by a predetermined distance.

In addition, a portion of the mother substrate irradiated with the laser beams is converted from an α-phase into a β-phase to form the modified zone 310 inside the mother substrate 100. The modified zone 310 undergoes physical and chemical structural deformation due to a non-linear photo-ionization mechanism by the very high frequency laser beams, thereby improving reactivity with an etching solution and physical variations including the index of reactivity.

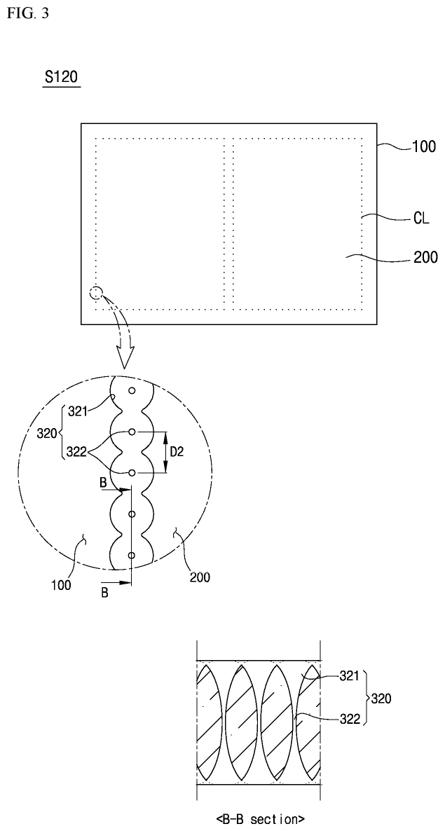

FIG. 3 is a view illustrating a modified zone-etching step of FIG. 1.

Referring to FIG. 3, the modified zone-etching step S120 may be the step of etching the modified zones 310 in the mother substrate 100 using an etching solution, with the mother substrate 100 dipped in the etching solution.

The etching solution may be a chemical etching solution, such as hydrofluoric acid (HF), nitric acid (HNO₃), potassium hydroxide (KOH), and the like.

In the modified zone-etching step S120, some portion of the surface of the mother substrate 100 having the modified zones 310 therein may be subjected to etching at a first etching rate and the other portion of the surface of the mother substrate 100 free from the modified zones 310 may be subjected to etching at a second etching rate slower than the first etching rate. That is, etching may be performed at a relatively high etching rate in the modified zones 310. For example, the first etching rate on the portion of the mother substrate formed with the modified zones 310 (in a β-phase state) may be 20 to 300 times the etching rate at a portion of the mother substrate (in an a-phase state) not formed with the modified zones 310.

That is, in the modified zone-etching step S120, the mother substrate 100 and the cell unit substrates 200 may be reduced in thickness and the modified zones 310 may be removed by etching.

In the modified zones 310, etching may be performed 20 to 300 times faster than in other regions not modified, and, as the modified zones 310 are removed through the modified zone-etching step S120, through-holes 320 may be formed along the cutting line CL.

The through-holes 320 may include taper holes 321 and fine holes 322.

The taper holes 321 may be formed to have a taper angle in a surface region of the mother substrate and the fine holes 322 may be formed in a central region of the mother substrate to connect the taper holes 321 formed at both sides on the surface of the mother substrate. That is, on the mother substrate 100 dipped in the etching solution, the taper holes 321 may be formed to have a taper angle while etching is performed at the fastest etching rate on the surface of the mother substrate 100 formed with the modified zones 310. Thereafter, the fine holes 322 may be formed to connect the taper holes at both sides on the surface of the mother substrate while etching is performed in the depth direction of the mother substrate.

As a result, each of the through-holes 320 is gradually grown over time to have a sandglass shape, as shown in FIG. 3, in which adjacent taper holes 321 extend to partially overlap each other along the cutting line CL.

For the mother substrate 100 including the modified zones 310 and the cell unit substrates 200, the etching rate may be adjusted depending on the intensity of laser beams, pulse duration, repeat speed, wavelength, focal distance, scan speed, concentration of the etching solution, and the like. That is, the taper angle of the taper holes 321 and the diameter of the fine holes 322 may be adjusted depending on the various variables.

The through-holes 320 may be arranged along the cutting line CL to be spaced apart from each other by a second distance D2. The second distance D2 may be the same as the first distance D1.

After completion of the modified zone-etching step S120, the mother substrate 100 including the cell unit substrates 200 may be removed from the etching solution.

The method of manufacturing the cell unit substrate according to this embodiment may further include a substrate cleaning step.

After completion of the modified zone-etching step S120, the mother substrate 100 may be removed from the etching solution, followed by cleaning the mother substrate 100 to remove the etching solution therefrom. Thereafter, the mother substrate 100 is subjected to the surface strengthening step S130.

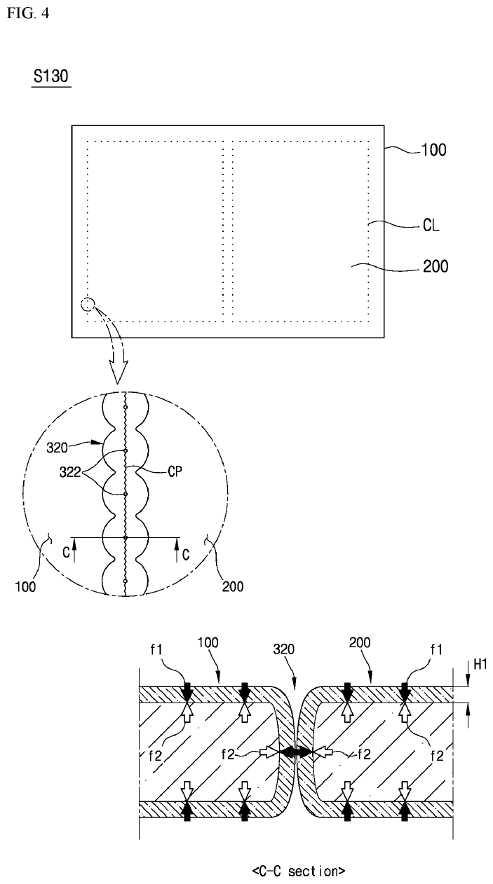

FIG. 4 is a view illustrating the surface strengthening step of FIG. 1.

Referring to FIG. 4, the surface strengthening step S130 may be the step of strengthening the surface of the mother substrate 100 having the modified zones 310 subjected to etching, with the mother substrate 100 dipped in a strengthening solution.

The strengthening solution may include KNO₃. For example, when the mother substrate 100 is dipped in the strengthening solution at 350° C. to 400° C. for a predetermined period of time, potassium ions (K⁺) in the strengthening solution replace sodium ions (Na⁺) of the mother substrate 100, whereby the surface of the mother substrate 100 can be strengthened through generation of compressive stress thereon by the potassium ions (K⁺) having a relatively large volume. Such surface strengthening proceeds from the surface of the substrate to the interior of the substrate over time, thereby forming a strengthened depth portion H1 on the surface of the substrate.

In the surface strengthening step S130, surface strengthening is performed to form a strengthened depth portion H1 on the through-holes 320 through generation of compressive stress on the through-holes 320 formed in the modified zone-etching step S120. As a result, each of the cell unit substrates 200 not separated from the mother substrate 100 can have a strengthened surface through generation of compressive stress f1 over the entire surface thereof including a cut section.

The strengthened depth on the surface of the through-hole 320 may be substantially smaller than the strengthened depth on the surface of the mother substrate 100 including the cell unit substrates 200. Alternatively, there may be no substantial difference therebetween.

The strengthened depth portion H1 may be adjusted depending on variables, such as the concentration of the strengthening solution, temperature, process time, and the like, or may be adjusted depending upon the intensity of laser beams in the modified zone-formation step S110, the diameter and pitch of the modified zones, and the etching degree in the modified zone-etching step S120. For reference, the index of refraction is changed depending upon the strengthened depth portion H1, which may be measured through measurement of the index of refraction.

Upon replacement of sodium ions with potassium ions through chemical strengthening, surface expansion also occurs on the interior surfaces of the through-holes 320 due to increase in compressive strength. Accordingly, a portion having low yield strength in a region between adjacent through-holes 320 along the cutting line CL can suffer from deformation, such as cracking or fracture, due to increase in compressive strength over the yield strength, and a connecting portion CP can be formed in the region between adjacent through-holes 320 due to such deformation.

As a result, although the cell unit substrates 200 can be structurally separated from the mother substrate 100 by the connecting portion CP connecting adjacent through-holes 320, specifically adjacent fine holes 322, connection between the cell unit substrates 200 and the mother substrate 100 can be maintained by expansive stress f2 corresponding to compressive stress f1, which provides surface strengthening in both regions with reference to the fine holes 322 and the connecting portion CP through the surface strengthening step S130.

As such, the cell unit substrates 200 maintained connected to the mother substrate 100 by expansive stress f2 in the surface strengthening step S130 can be easily separated therefrom by application of certain pressure in the substrate separation step S150.

On the other hand, the depth of the strengthened depth portion H1 on the surface of each of the through-holes 320 may be greater than half of a second distance D2.

If the depth of the strengthened depth portion H1 is less than half of the second distance D2, a region not subjected to surface strengthening can be generated between adjacent through-holes 320. As a result, a portion not subjected to surface strengthening is present in some region of a cut section of each of the cell unit substrates 200 separated from the mother substrate 100 in the substrate separation step S150 described below, thereby causing failure, such as deterioration in durability and loss of the surface strengthening effect due to breakage of balance of compressive stress.

Accordingly, the strengthened depth portion H1 on the surface of each of the through-holes 320 is set to have a depth greater than or equal to half of the second distance D2, thereby providing the surface strengthening effect over the entire surface of each of the cell unit substrates 200, that is, over the entire surface of each of the cell unit substrates 200 in cross-sectional view.

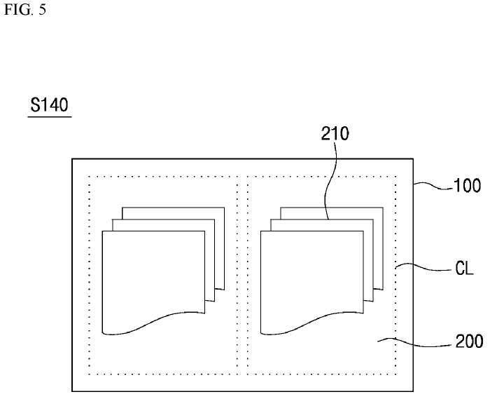

FIG. 5 is a view illustrating the substrate treatment step of FIG. 1.

Referring to FIG. 5, the substrate manufacturing method according to the embodiment of the invention may further include the substrate treatment step S140.

The substrate treatment step S140 may be performed after the surface strengthening step S130 and may be the step of processing the cell unit substrates 200 to provide a functional layer 210 to the cell unit substrates 200 on the mother substrate 100.

That is, the substrate treatment step S140 may be simultaneously performed with respect to the plurality of cell unit substrates 200, which are maintained connected to the mother substrate by the expansive stress f2 corresponding to the compressive stress f1 imparted by the surface strengthening step S130.

If the substrate treatment process is individually performed with respect to the plurality of cell unit substrates 200 after separation of the cell unit substrates 200 from the mother substrate 100, there can be a problem of significant deterioration in productivity. In particular, although a glass substrate is used as a material for displays or semiconductors, there are problems that compressive stress is not generated on a cut section of the glass substrate upon individual strengthening of the cell unit substrates 200 each having a very small size, causing loss of the strengthening effect due to breakage of stress balance, and that surface strengthening on the entire surface of a cell unit glass substrate requires a complicated process and entails increase in manufacturing cost.

According to the present invention, the substrate treatment process may be simultaneously performed with respect to the plurality of cell unit substrates 200 connected to a single mother substrate 100 after the surface strengthening step S130, thereby enabling substantial improvement in productivity while significantly improving strength and durability of the glass substrate.

The substrate treatment process performed on the cell unit substrates 200 may include a process of coating a printed functional layer on the cell unit substrates 200, a process of forming a pattern thereon, a process of forming a circuit thereon, and the like. For example, when the cell unit substrates are used as cover windows, the substrate treatment process may be a treatment process, such as printing, fingerprint coating, OCA attachment, panel lamination, and the like, and when the cell unit substrates are used as touch screen panels (TSP), the substrate treatment process may be a panel treatment process, such as pattern printing, lamination, and the like. In this way, the substrate treatment process may be performed in various ways depending on application fields of the corresponding cell unit substrates 200, without being limited to a particular process.

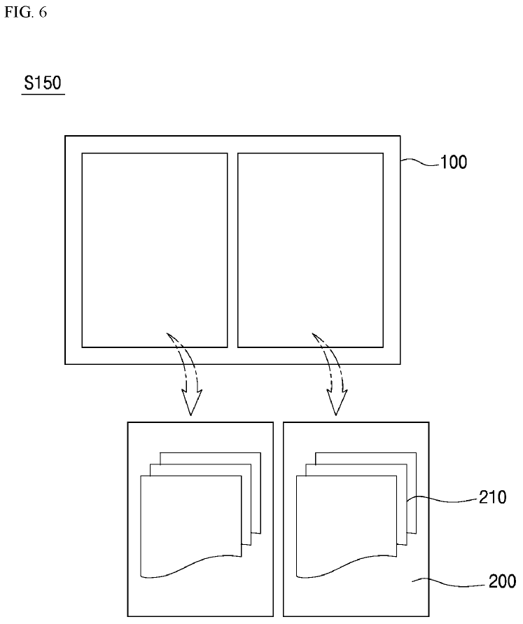

FIG. 6 is a view illustrating the substrate separation step of FIG. 1.

Referring to FIG. 6, the substrate separation step S150 may be performed after the substrate treatment step S140 and may be the step of separating the cell unit substrates 200 from the mother substrate 100 subjected to surface strengthening.

In the substrate separation step S150, the cell unit substrates 200 may be separated from the mother substrate 100 by applying physical pressure along the cutting line CL.

In the substrate separation step S150, a separation pressure applied to the mother substrate 100 or the cell unit substrates 200 may be set according to conditions for irradiation with laser beams in the modified zone-formation step S110, conditions for etching in the modified zone-etching step S120, and conditions for surface strengthening in the surface strengthening step S130. In this way, the cell unit substrates 200 can be easily separated from the mother substrate 100 by applying physical pressure greater than or equal to the preset separation pressure.

As a result, the separation pressure for the substrate separation step S150 may be set in consideration of pressure in the substrate treatment step S140 performed on the cell unit substrates 200 without separation of the cell unit substrates 200 from the mother substrate.

As described above, in the substrate manufacturing method according to this embodiment, since surface strengthening is performed with respect to the cell unit substrates 200 including the modified zones 310 before the cell unit substrates 200 are separated from the mother substrate 100, the strengthened depth portion H1 can be evenly formed on the entire surface of each of the cell unit substrates 200 on the mother substrate, thereby achieving substantial improvement in strength and durability of the cell unit substrates 200 while improving productivity of the substrate.

In addition, in the substrate manufacturing method according to this embodiment, substrate treatment process is simultaneously performed with respect to the cell unit substrates 200 on the mother substrate after surface strengthening of the cell unit substrates 200, thereby achieving further improvement in productivity of the substrate.

Further, in the substrate manufacturing method according to the present invention, surface strengthening is performed with respect to the cell unit substrates 200 including the modified zones 310 to have a uniform surface-strengthened depth on the entire surface of each of the cell unit substrates 200 without separation of the cell unit substrates 200 from the mother substrate 100, thereby enabling easy and accurate separation of the cell unit substrates 200 from the mother substrate 100 through application of separation pressure thereto.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the present invention.

### LIST OF REFERENCE NUMERALS

100: Mother substrate

200: Cell unit substrate

CL: Cutting line

310: Modified zone

320: Through-hole

1. A method of manufacturing a plurality of cell unit substrates from a mother substrate, the method comprising:
a modified zone-formation step in which modified zones are formed along a predetermined cutting line on the mother substrate to be spaced apart from each other by a first distance by irradiating the mother substrate with laser beams having an energy intensity within an ablation threshold of the mother substrate along the cutting line;
a modified zone-etching step in which through-holes are formed along the cutting line on the mother substrate to be spaced apart from each other by the first distance by etching the modified zones using an etching solution to remove the modified zones from the mother substrate, with the mother substrate dipped in the etching solution;
a surface strengthening step in which the mother substrate having the through-holes therein is subjected to surface strengthening, with the mother substrate dipped in a strengthening solution, to form a strengthened depth portion to a depth greater than half of the first distance on a surface of each of the through-holes; and
a substrate separation step in which the cell unit substrates are separated from the surface-strengthened mother substrate.

2. The method according to claim 1, further comprising:
a substrate treatment step in which the cell unit substrates are treated to provide a functional layer to each of the cell unit substrates on the mother substrate, after the surface strengthening step:

3. The method according to claim 1, wherein, in the modified zone-formation step, the modified zones are formed to have a diameter less than the first distance.

4. The method according to claim 1, wherein, in the substrate separation step, the cell unit substrates are separated from the mother substrate by physical pressure applied to the cell unit substrate.
